(19) United States
(12) Patent Application Publication
(10) Pub. No.: US 2006/0291668 A1
(43) Pub. Date: Dec. 28, 2006

(54) Vehicle audio system

(75) Inventors: Tsutomu Totani, Nagoya (JP); Yasuo Serikawa, Nagoya (JP)

Correspondence Address: KODA & ANDROLIA, 2029 CENTURY PARK EAST, SUITE 1140, LOS ANGELES, CA, 90067, US

(73) Assignee: Beat-Sonic Co., Ltd.

(21) Appl. No.: 11/415,599

(22) Filed: May 2, 2006

(30) Foreign Application Priority Data
Jun. 27, 2005 (JP) 2005-004876

(51) Int. Cl. H04B 1/00

(52) U.S. Cl. 381/86

(57) ABSTRACT

A vehicle audio system mountable on a vehicle compartment ceiling near a front window includes a flat substantially rectangular case having two opposite lengthwise side ends and a shaft hole defined in one of the side ends so as to extend lengthwise with respect to the one side end, the other side end having an end face, an audio system body located in the case and including an operation part mounted on the end face of the other side end of the case, and a pipe inserted in the shaft hole so that the case pivots about the pipe back-and-forth, the pipe having an end bent approximately at a right angle. The bent pipe end is mounted on a support mounted on the vehicle ceiling near the front window so that the case is pivotable into a position where each side end of the case extends perpendicularly to the front window.

### BACKGROUND OF THE INVENTION

1. Field of the invention

The present invention relates to a vehicle audio system which is installed in a vehicle, and more particularly to such a vehicle audio system which is usable in place of an existing vehicle sun visor thereby to also serve as a sun visor.

2. Description of the related art

Automobiles have recently been installed with a car navigation system as well as conventional car audio system. The car navigation system includes a display mounted on a central part of an instrument panel or a center console in a car room. The display is used to display a map or information transmitted from the Internet. Accordingly, the display is desirable to have high saturation and has recently been rendered larger in size. However, since various meters, glove compartments and the like are already provided on or in the instrument panel or center console, it is difficult to provide a large display in a car room.

In view of the above-described problem, JP-U-1-117946 discloses a car operation unit in which an operation part for a car-installed system and a display for operation of the system are provided in a sun visor installed in a car compartment. In the disclosed car operation unit, the operation part is provided in the sun visor, whereas a space for the display with a large screen and other car-installed equipment is defined on the instrument panel or in the center console.

However, the operation part of the above-described car operational port can be operated only when the sun visor is pulled down. Furthermore, when the sun visor is caused to pivot so as to be parallel to a door window in order that light incident from the door window side is cut off, the operation part of the car operational port is opposed to the door window, whereupon the car operational port cannot be operated.

### SUMMARY OF THE INVENTION

Therefore, an object of the present invention is to provide a vehicle audio system which can be used in place of an existing vehicle sun visor and has an easy operability.

The present invention provides a vehicle audio system which is mountable on a ceiling of a vehicle compartment near a front window of a vehicle, the system comprising a flat substantially rectangular case having two opposite lengthwise side ends and a shaft hole defined in one of the side ends thereof so as to extend lengthwise with respect to the said one side end, the other side end of the case having an end face, an audio system body provided in the case and including an operation part mounted on the end face of said other side end of the case, and a pipe inserted in the shaft hole of the case so that the case pivots about the pipe back-and-forth, the pipe having an end bent approximately at a right angle, wherein the bent end of the pipe is mounted in a support provided on the vehicle ceiling near the front window so that the case is pivotable into a position where each side end of the case extends perpendicularly to the front window.

The flat case of the vehicle audio system is mounted on the pipe so as to pivot back-and-forth. Furthermore, the bent end of the pipe is mounted on the support provided on the vehicle ceiling near the front window so that the case is pivotable in a horizontal direction into the position where each side end of the case extends perpendicularly to the front window. Consequently, the vehicle audio system of the invention can be used in place of the existing sun visor.

Additionally, since the operation part is mounted on the end face of the side end of the case, the audio system can be operated whether the case is located in parallel to the front window or the door window.

In one embodiment, either side end of the case has a slot located at a predetermined position so that a storage medium is insertable into the slot, whereby sound data is read from and written onto the storage medium at the audio system body. Consequently, the storage medium can be set on the audio system while the case remains at the vehicle ceiling side.

In another embodiment, the case has an upper side formed with an attachment recess. The system further comprises a holder enclosing a storage medium which is capable of storing sound data and from and onto which sound data is readable and writable. The holder includes a lid which is substantially co-planar with the upper side of the case. Consequently, the storage medium can be prevented from falling off by vibration of the case or the like.

In further another embodiment, the vehicle audio system is connected to a vehicle audio system including an output unit and the output unit such as loud speakers or display is operable in synchronization with recognition of stored sound data by the audio system body when a power supply is connected to the vehicle audio system, when the storage medium is inserted into the slot, or when the storage medium is put into the holder. Consequently, operation for sound reproduction or recording can be rendered easier.

### BRIEF DESCRIPTION OF THE DRAWINGS

Other objects, features and advantages of the present invention will become clear upon reviewing the following description of the embodiment, with reference to the accompanying drawings, in which:

FIG. 1 is a perspective view of a vehicle audio system in accordance with a first embodiment of the invention;

FIG. 2 is a perspective view of the vehicle audio system, explaining a manner of using the vehicle audio system;

FIG. 3 is a perspective view of the vehicle audio system, explaining the using manner;

FIG. 4 is a perspective view of the vehicle audio system, explaining the using manner;

FIG. 5 is a perspective view of the vehicle audio system in accordance with a second embodiment of the invention;

FIG. 6 is perspective view of an operation part of the vehicle audio system in accordance with a third embodiment of the invention; and

FIG. 7 is a perspective view of an operation part of the vehicle audio system in accordance with a fourth embodiment of the invention.

### DETAILED DESCRIPTION OF THE INVENTION

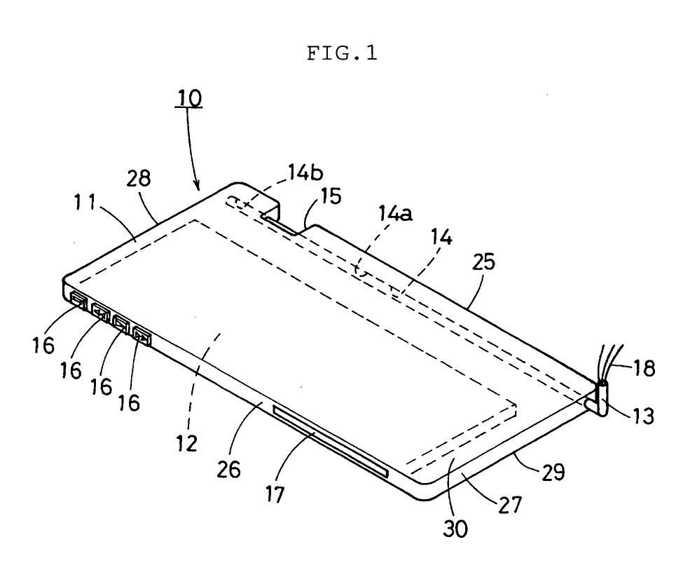

Several embodiments of the present invention will be described with reference to the accompanying drawings. FIGS. 1 to 4 illustrate a first embodiment of the invention. Referring to FIG. 1, reference numeral 10 designates a vehicle audio system of the first embodiment. The vehicle audio system 10 includes a case 11 and an audio system body 12 enclosed in the case 11. The case 11 has a notch 15 formed by cutting out a predetermined part of one of two opposite lengthwise ends. The case 11 further has a through hole 14a extending through the case 11 from a right end 27 to the notch 15 and a bottomed hole 14b extending from the notch 15 toward a left end 28 as viewed in FIG. 1. The holes 14a and 14b constitute a shaft hole 14. An operation part 16 is provided on the lengthwise end of the case 11 opposed to the notch 15. An insertion slot 17 is also provided in the lengthwise end of the case 11. A storage medium comprised of an optical disk such as a compact disc (CD) or digital versatile disk (DVD) is adapted to be inserted into the insertion slot 17.

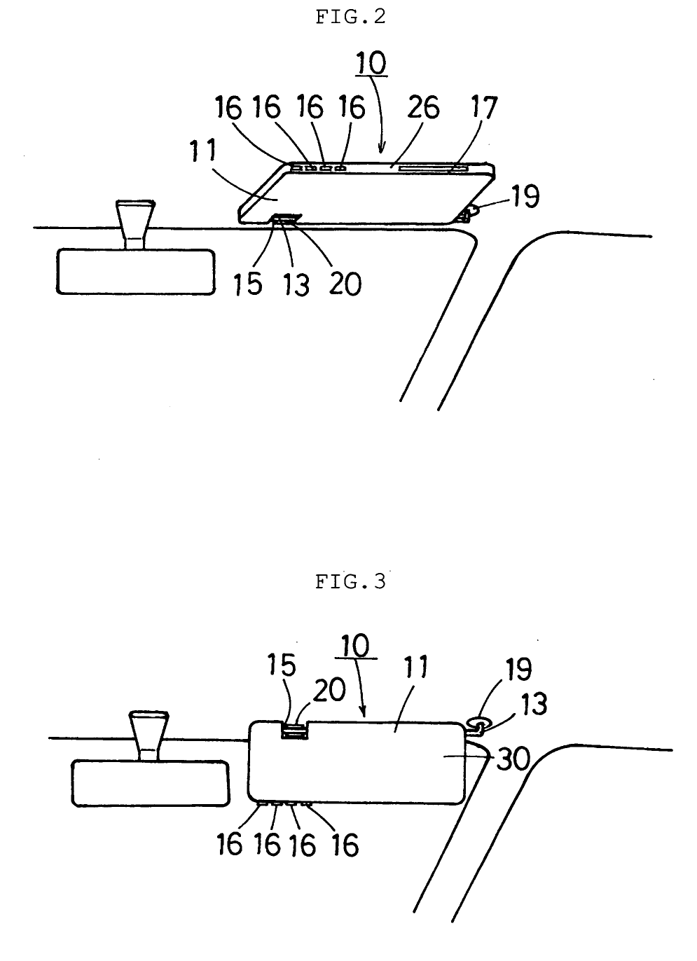

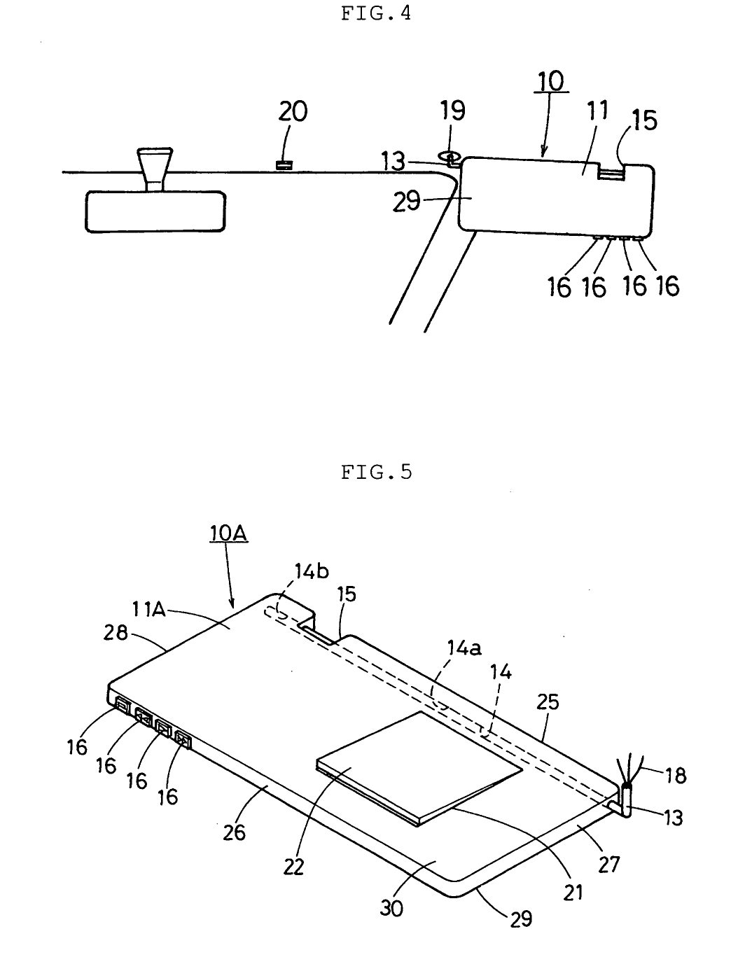

A pipe 13 has one end bent approximately at a right angle. A wire harness 18 is inserted through the pipe 13 to connect the audio system body 12 to loud speakers, a display (neither shown) and the like. The wire harness 13 is wired along the vehicle body including the vehicle ceiling, pillars and the like. The pipe 13 is inserted into the shaft hole 14. As a result, the case 11 pivots about the pipe 13 back-and-forth. Furthermore, a support 19 is fixed to the vehicle ceiling or front pillar near a front window. The bent end of the pipe 13 is mounted on the support 19 so that the case 11 is supported. As a result, the pipe 13 pivots about the support 19 from a position where the case 11 is supported so as to extend along a front window as shown in FIG. 2 or 3 into a position where the case 11 extends perpendicularly to the front window or along a door window as shown in FIG. 4.

The audio system body 12 is provided with a circuit or a program for executing a function of recognizing data stored on an optical disk such as a CD or DVD by the audio system body 12 and energizing the output unit of the audio system such as the loud speakers, display or the like through the wire harness 18 when the audio system body 12 is energized or when the optical disk is inserted into the slot.

The vehicle audio system 10 will operate as follows. Referring to FIG. 2, a lock bracket 20 is mounted on the vehicle ceiling near the front window. A part of the pipe 13 exposed in the notch 15 is engaged with the lock bracket 20, whereby the pipe 13 is locked. As the result of pivotal movement, an upper corner of the lower end 26 of the case 11 is in abutment with the vehicle ceiling. Referring to FIG. 3, the case 11 is caused to pivot about the pipe 13 downward from the state as shown in FIG. 2 while the pipe 13 is in engagement with the bracket 20. The operation part 16 and the slot 17 are moved back-and-forth as viewed at the driver's seat side.

Referring now to FIG. 4, when the pipe 13 is disengaged from the lock bracket 20, the case 11 is caused to pivot so that the lower end 26 of the case 11 is directed downward. Furthermore, the case 11 is caused to pivot to the right so as to be opposed to the door window.

The operation part 16 and the slot 17 are directed downward or located frontward as viewed at the driver's seat side as shown in FIGS. 2, 3 and 4. In this case, when an optical disk is inserted into the slot 17, the vehicle audio system 10 is energized. The loud speakers (not shown) or a display (not shown) is energized in synchronization with energization of the system 10, so that sound data stored on the optical disk is reproduced.

The storage medium comprised of the optical disk such as the CD, DVD or the like is used in the foregoing embodiment. However, another storage medium such as a flash memory may be used in order that the weight of the vehicle audio system 10 may be reduced or skip due to vibration or oscillation may be prevented. Alternatively, a cartridge storage medium such as a hard disk with a large capacity may be used so that a large amount of data is stored. Thus, a storage medium which has a good portability and is arranged to prevent degradation of sound may be used.

In the foregoing embodiment, the operation part 16 and the slot 17 are within easy reach in each of the cases as shown in FIGS. 2 to 4. Accordingly, the vehicle audio system 10 has a good operability, and a disk can easily be inserted.

Furthermore, since the support 19 on which the existing vehicle sun visor is mounted is used in the vehicle audio system 10, the existing sun visor can easily be replaced by the vehicle audio system 10.

Additionally, a space occupied by an indoor instrument panel or center console on each of which a vehicle audio system is not necessary, a display with a large screen can be installed utilizing the space.

FIG. 5 illustrates a second embodiment of the invention. An attachment recess 21 is formed in a rear part 30 of the upper side of the case 11 located at the right end thereof. A holder 22 for accommodating an optical disk is fitted in the attachment recess 21 so as to pivot. An upper surface of the holder 22 is co-planar with the upper surface of the case 11.

According to the second embodiment, the holder 22 can prevent dust from entering a clearance between the attachment recess 21 and the case 11. Furthermore, the storage medium such as an optical disk can be prevented from falling off when the case 11 is directed downward.

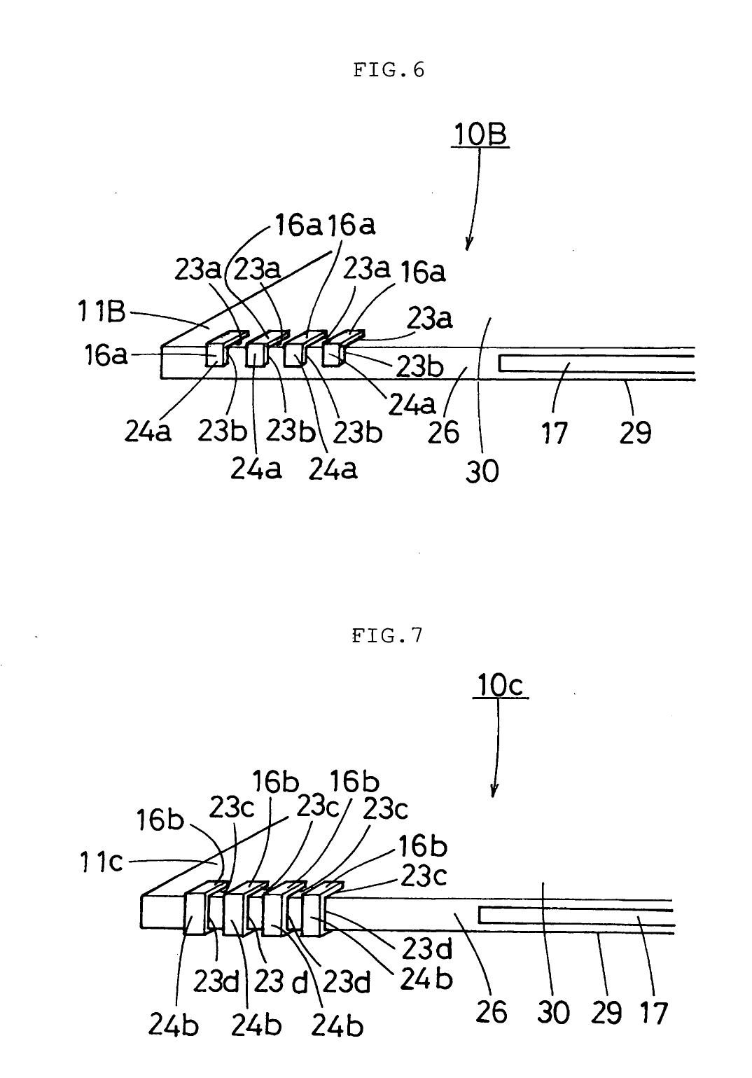

FIG. 6 illustrates a third embodiment of the invention. In the vehicle audio system 10B, for example, four recesses 23a are formed in the upper surface of the case 11B. The lengthwise side 26 has four recesses 23b which are formed so as to be continuous to the recesses 23a respectively. Generally L-shaped switches 24a are fitted in the continuous recesses 23a and 23b respectively so that the operation part 16a is exposed at the corner of the lower end 26.

The L-shaped switches 24a can be operated at two sides, that is, both at the upper surface side and at the lengthwise side 26. Accordingly, the lower end 26 of each switch 24a is operated when the case 11 is directed upward as shown in FIG. 2, whereas the upper side 30 of each switch 24a is operated when the case 11 is directed downward as shown in FIG. 3.

FIG. 7 illustrates a fourth embodiment of the invention. The fourth embodiment is directed to another arrangement of the operation part. Each fitting recess 23c extends from the front side 29 to the lower end 26. For example, the operation part 16b includes four generally C-shaped switches 24 as shown in FIG. 7. Each switch 24 is fitted in two fitting recesses 23c formed in the underside 29 and the upper side 30 respectively and a fitting recess 23d formed in the lower end 26 so as to be continuous to the fitting recesses 23c. Each switch 24b is fitted in the recesses 23c and 23d so as to be exposed.

According to the fourth embodiment, the C-shaped switches 24b can be operated at three sides, that is, at the front, rear and lower side of the case 11C. Accordingly, each switch 24b is operated at lower end 26 side of the case 11C when the case 11C is directed upward as shown in FIG. 2. Each switch 24b is operated at the rear side 30 of the case 11C when the case 11C is directed downward as shown in FIG. 3. Furthermore, each switch 24b is operated at the front side 29 of the case 11C when the case 11C is located opposite the door window as shown in FIG. 4.

The operation part 16, 16a or 16b includes pushbutton switches in each of the foregoing first to fourth embodiments. Touch-sensitive switches or a remote-control receiving part may be provided in the lower end of the case 11, 11A, 11B or 11C, whereupon the operability can also be improved.

The foregoing description and drawings are merely illustrative of the principles of the present invention and are not construed in a limiting sense. Various changes and modifications will become apparent to those of ordinary skill in the art. All such changes and modifications are seen to fall within the scope of the invention as defined by the appended claims.

We claim:

1. A vehicle audio system which is mountable on a ceiling of a vehicle compartment near a front window of a vehicle, the system comprising:
a flat substantially rectangular case having two opposite lengthwise side ends and a shaft hole defined in one of the side ends thereof so as to extend lengthwise with respect to the said one side end, the other side end of the case having an end face;
an audio system body provided in the case and including an operation part mounted on the end face of said other side end of the case; and
a pipe inserted in the shaft hole of the case so that the case pivots about the pipe back-and-forth, the pipe having an end bent approximately at a right angle, wherein the bent end of the pipe is mounted on a support provided on the vehicle ceiling near the front window so that the case is pivotable into a position where each side end of the case extends perpendicularly to the front window.

2. The vehicle audio system of claim 1, wherein either side end of the case has a slot located at a predetermined position so that a storage medium is insertable into the slot, whereby sound data is read from and written onto the storage medium at the audio system body.

3. The vehicle audio system of claim.1, wherein the case has an upper side formed with an attachment recess, the system further comprising a holder enclosing a storage medium which is capable of storing sound data and from and onto which sound data is readable and writable, wherein the holder includes a lid which is substantially co-planar with the upper side of the case.

4. The vehicle audio system of claim 2, wherein the case has an upper side formed with an attachment recess, the system further comprising a holder enclosing a storage medium which is capable of storing sound data and from and onto which sound data is readable and writable, wherein the holder includes a lid which is substantially co-planar with the upper side of the case.

5. The vehicle audio system of claim 1, wherein the system is connected to a vehicle audio system including an output unit and the output unit is operable in synchronization with recognition of stored sound data by the audio system body when a power supply is connected to the vehicle audio system.

6. The vehicle audio system of claim 2, wherein the system is connected to a vehicle audio system including an output unit and the output unit is operable in synchronization with recognition of stored sound data by the audio system body when a power supply is connected to the vehicle audio system or when the storage medium is inserted into the slot.

7. The vehicle audio system of claim 3, wherein the system is connected to a vehicle audio system including an output unit and the output unit is operable in synchronization with recognition of stored sound data by the audio system body when a power supply is connected to the vehicle audio system or when the storage medium is put into the holder.

8. The vehicle audio system of claim 4, wherein the system is connected to a vehicle audio system including an output unit and the output unit is operable in synchronization with recognition of stored sound data by the audio system body when a power supply is connected to the vehicle audio system or when the storage medium is inserted into the slot or put into the holder.
